(19) United States
(12) Patent Application Publication
(10) Pub. No.: US 2005/0019483 A1
(43) Pub. Date: Jan. 27, 2005

(54) Method and apparatus for manufacturing color filter substrate, method and apparatus for manufacturing electroluminescent substrate, method for manufacturing electro-optical device, and method for manufacturing electronic apparatus

(76) Inventors: Tomomi Kawase, Matsumoto-shi (JP); Masaharu Shimizu, Suwa-Gun (JP)

Correspondence Address: HARNESS, DICKEY & PIERCE, P.L.C., P.O. BOX 828, BLOOMFIELD HILLS, MI, 48303, US

(21) Appl. No.: 10/859,473

(22) Filed: Jun. 2, 2004

(30) Foreign Application Priority Data
Jun. 2, 2003 (JP) 2003-156837

(51) Int. Cl. B05D 5/06

(52) U.S. Cl. 427/66; 427/421.1; 427/64; 118/715

(57) ABSTRACT

A method is provided for manufacturing a color filter substrate capable of preventing foreign substances from being attached to a base member. The method includes a step of discharging a liquid filter material from an inkjet head nozzle included in a recording head to the base member as liquid drops. In the discharging step, the liquid drops are discharged in a state where the base member is substantially vertically arranged. A color filter substrate manufacturing apparatus is preferably provided in a clean room that is maintained clean by an air current that flows from the top of the room to the bottom.

### RELATED APPLICATIONS

This application claims priority to Japanese Patent Application No. 2003-156837 filed Jun. 2, 2003 which is hereby expressly incorporated by reference herein in its entirety.

### BACKGROUND

1. Technical Field of the Invention

The present invention relates to an apparatus and a method for manufacturing a color filter substrate used for performing color display. The present invention also relates to an apparatus and a method for manufacturing an electroluminescent substrate in which light-emitting elements are formed on a substrate. The present invention also relates to a method for manufacturing an electro-optical device such as a liquid crystal device or an electroluminescent device. Furthermore, the present invention relates to a method for manufacturing electronic apparatuses, such as a mobile telephone, a portable information terminal, and a personal digital assistant (PDA).

2. Description of the Related Art

Electro-optical devices, such as liquid crystal devices and electroluminescent devices, are widely used for electronic apparatuses such as mobile telephones and personal, portable information terminals, and personal digital assistants (PDA). For example, the electro-optical devices are used for visually displaying various information items relating to electronic apparatuses.

In a case where a liquid crystal device is used as an electro-optical device, when color display is performed by the liquid crystal device, a color filter substrate is provided in the liquid crystal device. The color filter substrate is manufactured by forming color filters on a base member composed of, for example, transmissive glass. The color filters are optical components obtained by arranging the filter components of the three colors R (red), G (green), and B (blue) or the filter components of the three colors C (cyan), M (magenta), and Y (yellow) in a predetermined arrangement in plan view.

When an electroluminescent device is used as an electro-optical device, an electroluminescent substrate is commonly provided in the electroluminescent device. The electroluminescent substrate is formed, for example, by arranging a plurality of light-emitting elements on a base member composed of transmissive glass in a matrix.

When the color filter substrate is manufactured by forming the color filters on the base member, that is, when the plurality of filter components are formed on the base member, a conventional method for supplying the material of the filter components onto the base member using an inkjet technology has been used. According to the method, a filter material is discharged from a liquid drop discharging portion, such as nozzles, to the base member as liquid drops (For example, see Japanese Unexamined Patent Application Publication No. 2002-372614 (page 3 and FIG. 1)).

According to the conventional method for manufacturing a color filter substrate, a base member, to which liquid drops are discharged, is horizontally arranged, and a recording head having nozzles moves in parallel in a horizontal plane. When the base member is horizontally arranged, dust and other foreign substances are easily attached to the base member.

The present invention is designed to solve the above problem, and it is an object of the present invention to provide a method for manufacturing a color filter substrate capable of preventing foreign substances from being attached to the base member and an apparatus for manufacturing the same, a method for manufacturing an electroluminescent substrate and an apparatus for manufacturing the same, a method for manufacturing an electro-optical device, and a method for manufacturing an electronic apparatus.

### SUMMARY

To achieve the above object, the present invention provides a method for manufacturing a color filter substrate having a base member and a color filter formed on the base member, the method comprising a step of discharging a liquid filter material from a liquid drop discharging portion to the base member as liquid drops, wherein, in the discharging step, the liquid drops are discharged in a state where the base member is substantially vertically arranged.

According to the above structure, the ‘base member’ is composed of, for example, transmissive glass or transmissive plastic. Furthermore, The filter material is composed of materials of R (red), G (green), and B (blue) or C (cyan), M (magenta), and Y (yellow) colors. The filter material is not limited to special materials, however, it may consist of pigments of various colors made of a transparent material such as resin and a liquid material composed of a glycol-based solvent such as ethylene glycol. Also, the filter material may be a liquid material obtained by dissolving a solid body composed of a pigment, a surface-active agent, and a solvent in an appropriate solvent.

Furthermore, the step of discharging the filter material as liquid drops can be performed by a liquid drop discharging technique, that is, by an inkjet technology. According to the inkjet technology, piezoelectric elements and nozzles are preferably provided in an ink storage chamber, and ink, that is, a liquid material is preferably discharged from the nozzles as liquid drops according to a change in the volume of the ink storage chamber due to the vibration of the piezoelectric elements. In addition, according to the inkjet technology, the ink may be discharged from the nozzles as the liquid drops by expanding the ink stored in the ink storage chamber by heating. Furthermore, the liquid drop discharging portion includes minute apertures such as the nozzles of an inkjet head.

According to the method for manufacturing the color filter substrate having the above structure, since the base member is substantially vertically arranged, it is possible to prevent an foreign substance such as dust from accumulating on the corresponding base member and to thus prevent the foreign substance from being attached to the corresponding base member. Also, in a conventional spin coating method, it is not possible to vertically erect the base member. However, according to the present invention using a liquid drop discharging technique, it is possible to discharge liquid drops to the base member in a state where the base member is vertically erected.

Furthermore, the present invention provides a method for manufacturing a color filter substrate having a base member and a color filter formed on the base member, the method comprising a step of discharging a liquid filter material from a liquid drop discharging portion to the base member as liquid drops, wherein, in the discharging step, the base member is inclined at an angle of about ±5° with respect to vertical. According to the method for manufacturing the color filter substrate, since the same components as those of the method for manufacturing the color filter substrate have the same functions as those of the components of the method for manufacturing the color filter substrate, the description thereof will be omitted.

According to the method for manufacturing the color filter substrate, since the base member is arranged so as to be inclined at an angle of about ±5° with respect to vertical, it is possible to prevent foreign substances from accumulating on the base member and to thus prevent foreign substances from being attached to the corresponding base member. According to an experiment by the present inventor, it is possible to significantly reduce the amount of foreign substances attached to the corresponding substrate when the angle at which the substrate is tilted with respect to vertical is within 5°.

According to the method for manufacturing the color filter substrate having the aforementioned structure, the liquid drops are discharged from the liquid drop discharging portion substantially in a normal direction relative to the base member. Therefore, it is possible to easily control the positions where the liquid drops land on the base member.

According to the method for manufacturing the color filter substrate having the aforementioned structure, ions having electric potential opposite to the charged electric potential of the base member are supplied to the base member. Therefore, since the static electricity of the base member can be discharged, it is possible to prevent foreign substances from being attached to the base member due to static electricity. In addition, in this case, the ions are supplied from the side of the base member that does not face the liquid drop discharging portion. Therefore, it is possible to supply a sufficient amount of ions to the base member. Furthermore, the movement of the liquid drop discharging portion is not obstructed by the presence of the ion supplying means.

According to the method for manufacturing the color filter substrate having the aforementioned structure, the base member is provided in a chamber where the current of air flows up and down. A clean room is known as a circumstance under which electronic parts having a minute structure, such as semiconductor devices, are manufactured. In the clean room, for example, foreign substances are withdrawn by the current of air that flows up and down, so that the foreign substances do not exist in the clean room. As mentioned above, under the circumstance where air flows up and down, when the base member is horizontally placed, foreign substances are easily accumulated on the base member. However, when the base member is vertically arranged according to the present invention, it is possible to significantly reduce the amount of foreign substances accumulated on the base member.

According to the method for manufacturing the color filter substrate having the aforementioned structure, a dustproof filter is provided on the upstream side of the base member in the air current. As mentioned above, air flows up and down in the clean room, and the dustproof filter is arranged on the upstream side of the base member in the direction of airflow to withdraw foreign substances. Therefore, it is possible to further prevent foreign substances from being accumulated on the base member.

According to the method for manufacturing the color filter substrate having the aforementioned structure, the liquid drop discharging portion is an inkjet head using piezoelectric elements. In addition, in the method for manufacturing the color filter substrate having the aforementioned structure, the liquid drop discharging portion is an inkjet head for discharging a liquid filter material by bubbles generated by thermal energy.

Further, the present invention provides an apparatus for manufacturing a color filter substrate having a base member and a color filter formed on the base member, and the apparatus comprises base member supporting means for substantially vertically supporting the base member; liquid drop discharging means for discharging a liquid filter material from a liquid drop discharging portion to the base member as liquid drops; and scanning moving means for moving the base member parallel relative to the liquid drop discharging portion.

All of the structures capable of substantially vertically supporting the base member can be used in the ‘base member supporting means’. For example, a structure where the base member is absorbed (vacuumed) and fixed to a base by absorbing air in a state where the base member two-dimensionally comes into contact with the base that is a plate shaped member having a slightly larger area than that of the base member, a structure where the base member is fixed to the base by an appropriate mechanical clamp in a state where the base member two-dimensionally comes into contact with the base, or a structure where the base member is fixed to the base by an appropriate adhesive may be used.

A discharging device having an arbitrary structure capable of discharging a liquid material as liquid drops can be used as the ‘liquid drop discharging means’. For example, a structure in which a liquid material is discharged by changing the volume of a liquid chamber by the vibration of piezoelectric elements, or a structure in which a liquid material in the liquid chamber is discharged by expanding and contracting the liquid material by heating and cooling may be used. The ‘liquid drop discharging portion’ may be composed of minute apertures such as nozzles. The ‘scanning movement means’ may have an arbitrary structure in which a member for supporting the base member can move in parallel in two directions orthogonal to each other. A parallel movement mechanism in plan view, referred to as an X-Y table, may be used as such a structure.

According to the apparatus for manufacturing the color filter substrate having the above structure, since the base member is substantially vertically arranged, it is possible to prevent an foreign substance such as dust from being accumulated on the corresponding base member and to thus prevent the foreign substance from being attached to the corresponding base member. In addition, According to the conventional spin coating method, it is impossible to vertically erect the base member. However, according to the present invention in which the liquid drop discharging technique is used, it is possible to discharge liquid drops to the base member in a state where the base member is vertically erected.

Furthermore, the present invention provides another apparatus for manufacturing a color filter substrate having a base member and a color filter formed on the base member, and the apparatus comprises base member supporting means for supporting the base member so that the base member is inclined at an angle of about ±5° with respect to vertical; liquid drop discharging means for discharging a liquid filter material from a liquid drop discharging portion to the base member as liquid drops; and scanning moving means for moving the base member parallel relative to the liquid drop discharging portion. According to the apparatus for manufacturing the color filter substrate, since the same components as those used for the device for manufacturing the color filter substrate have the same functions, the description thereof will be omitted.

According to the apparatus for manufacturing the color filter substrate, since the base member is inclined at an angle of about ±5° with respect to vertical, it is possible to prevent a foreign substance such as dust from being accumulated on the-corresponding base member and to thus prevent the foreign substance from being attached to the corresponding base member. According to an experiment of the present inventor, when the angle at which a substrate is inclined with respect to the vertical is within a range of less than 5°, it is possible to significantly reduce the amount of foreign substance attached to the corresponding substrate.

Furthermore, the present invention provides a method for manufacturing an electroluminescent substrate having a base member and light-emitting elements formed on the base member, and the method comprises a step of discharging a light-emitting-element material from a liquid drop discharging portion to the base member as liquid drops, wherein, in the discharging step, the liquid drops are discharged in a state where the base member is substantially vertically arranged.

According to the above structure, the ‘base member’ is composed of, for example, transmissive glass or transmissive plastic. Furthermore, the ‘light-emitting element’ is an electro-optical material used for an electroluminescent device and emits one of the three primary colors R (red), G (green), and B (blue) when a voltage is applied thereto.

Furthermore, the ‘step of discharging the light-emitting-element material as liquid drops’ can be performed by a liquid drop discharging technique, that is, by an inkjet technology. According to the inkjet technology, piezoelectric elements and nozzles are preferably provided in an ink storage chamber, and ink, that is, a liquid material is preferably discharged from the nozzles as liquid drops according to a change in the volume of the ink storage chamber due to the vibration of the piezoelectric elements. In addition, according to the inkjet technology, the ink may be discharged from the nozzles as the liquid drops by expanding the ink stored in the ink storage chamber by heating. Furthermore, the ‘liquid drop discharging portion’ includes, for example, minute apertures such as the nozzles of an inkjet head.

According to the method for manufacturing the electroluminescent substrate having the above structure, since the base member is substantially vertically, it is possible to prevent a foreign substance such as dust from being accumulated on the corresponding base member and to thus prevent the foreign substance from being attached to the corresponding base member. According to the conventional spin coating method, the base member cannot be vertically erected. However, according to the present invention using the liquid drop discharging technique, it is possible to discharge liquid drops to the base member in a state where the base member is vertically erected.

Further, the present invention provides another method for manufacturing an electroluminescent substrate having a base member and light-emitting elements formed on the base member, and the method comprises a step of discharging a light-emitting-element material from a liquid drop discharging portion to the base member as liquid drops, wherein, in the discharging step, the base member is inclined at an angle of about ±5° with respect to vertical. In the manufacturing method, since the same components as those used for the aforementioned manufacturing method have the same functions, the description thereof will be omitted.

According to the method for manufacturing the electroluminescent substrate, since the base member is inclined at an angle of about ±5° with respect to the vertical, it is possible to a foreign substance such as dust from being accumulated on the corresponding base member and to thus prevent the foreign substance from being attached to the corresponding base member. According to the experiment of the present inventor, when the angle at which the substrate is inclined with respect to the vertical is within 5°, it is possible to significantly reduce the amount of foreign substances attached to the corresponding substrate.

According to the method for manufacturing the electroluminescent substrate having the above structure, the liquid drops are discharged from the liquid drop discharging portion substantially in a normal direction relative to the base member. Therefore, it is possible to easily control the liquid drop landing position on the base member.

According to the method for manufacturing the electroluminescent substrate having the above structure, ions having electric potential opposite to the charged electric potential of the base member are supplied to the base member. Therefore, since the static electricity of the base member can be discharged, it is possible to prevent foreign substances from being attached to the base member due to the static electricity. In addition, in this case, the ions are supplied from the side of the base member that does not face the liquid drop discharging portion. Therefore, it is possible to supply a sufficient amount of ions to the base member. Furthermore, it is possible to prevent the movement of the liquid drop discharging portion from being obstructed by the presence of the ion supplying means.

Further, according to the method for manufacturing the electroluminescent substrate having the above structure, the base member is provided in a chamber where the current of air flows up and down. A clean room is well-known as a circumstance under which electronic parts having a minute structure, such as semiconductor devices, are manufactured. In the clean room, for example, foreign substances are withdrawn by the current of air that flows up and down, so that the foreign substances do not exist in the clean room. As mentioned above, when the base member is horizontally placed under the circumstance where air flows up and down, foreign substances are easily accumulated on the base member. However, when the base member is vertically arranged according to the present invention, it is possible to significantly reduce the amount of foreign substances accumulated on the base member.

According to the method for manufacturing the electroluminescent substrate having the above structure, a dustproof filter is provided on the upstream side of the base member in the air current. As mentioned above, air flows up and down in the clean room, and the dustproof filter is arranged on the upstream side of the base member in the air current to withdraw foreign substances. Therefore, it is possible to further prevent foreign substances from being accumulated on the base member.

According to the method for manufacturing the electroluminescent substrate having the above structure, the liquid drop discharging portion is an inkjet head using piezoelectric elements. In addition, according to the method for manufacturing the electroluminescent substrate having the above structure, the liquid drop discharging portion is an inkjet head for discharging a material by bubbles generated by thermal energy.

Furthermore, the present invention provides an apparatus for manufacturing an electroluminescent substrate having a base member and light-emitting elements formed on the base member, and the apparatus comprises base member supporting means for substantially vertically supporting the base member; liquid drop discharging means for discharging a light-emitting-element material from a liquid drop discharging portion to the base member as liquid drops; and scanning moving means for moving the base member parallel relative to the liquid drop discharging portion.

The respective components, such as the base member supporting means, the liquid drop discharging means, the liquid drop discharging portion, and the scanning movement means, have the same functions as those of the same components used in the apparatus for manufacturing the color filter substrate according to the above-mentioned present invention. Therefore, the description thereof will be omitted.

According to the apparatus for manufacturing the electroluminescent substrate having the above structure, since the base member is substantially vertically arranged, it is possible to prevent a foreign substance such as dust from being accumulated on the corresponding base member and to thus prevent the foreign substance from being attached to the corresponding base member. Also, according to the conventional spin coating method, it is not possible to vertically erect the base member. However, according to the present invention using the liquid drop discharging technique, it is possible to discharge liquid drops to the base member in a state where the base member is vertically erected.

Furthermore, the present invention provides another apparatus for manufacturing an electroluminescent substrate having a base member and light-emitting elements formed on the base member, and the apparatus comprises base member supporting means for supporting the base member so that the base member-is inclined at an angle of about ±5° with respect to vertical; liquid drop discharging means for discharging a light-emitting-element material from a liquid drop discharging portion to the base member as liquid drops; and scanning moving means for moving the base member parallel relative to the liquid drop discharging portion. According to the apparatus for manufacturing the electroluminescent substrate, since the same components as those used in the aforementioned manufacturing apparatus have the same function, the description thereof will be omitted.

According to the apparatus for manufacturing the electroluminescent substrate, since the base member is inclined at an angle of 0° to ±5° with respect to the vertical, it is possible to prevent a foreign substance such as dust from being accumulated on the corresponding base member and to thus prevent foreign substances from being attached to the corresponding base member. According to the experiment of the present inventor, it is possible to significantly reduce the amount of foreign substances attached to the corresponding substrate when the angle at which the substrate is inclined with respect to vertical is within 5°.

Furthermore, the present invention provides a method for manufacturing an electro-optical device obtained by forming an electro-optical material layer on a color filter substrate, and the method comprises a step of performing a method for manufacturing a color filter substrate as described above.

The electro-optical material used for the method for manufacturing the electro-optical device is, for example, a liquid crystal layer, and the electro-optical device, in which the liquid crystal layer is used, is a liquid crystal device. When the color filter substrate is used for the liquid crystal device, it is possible to perform color display. According to the method for manufacturing the electro-optical device of the present invention, since the method for manufacturing the color filter substrate according to the present invention is used, it is possible to prevent foreign substances from being attached to the base member used for the color filter substrate and to thus perform high-quality color display.

Further, the present invention provides another method for manufacturing an electro-optical device obtained by forming electrodes on an electroluminescent substrate, and the method comprises a step of performing a method for manufacturing an electroluminescent substrate as described above.

The electro-optical material used for the method for manufacturing the electro-optical device is, for example, an electroluminescent element, and the electro-optical device, in which the electroluminescent element is used, is an electroluminescent device. According to the electroluminescent device, when light-emitting elements corresponding to the three primary colors R, G, and B are used as the electroluminescent elements, it is possible to perform color display. According to the method for manufacturing the electro-optical device of the present invention, since the method for manufacturing the electroluminescent substrate according to the present invention is used, it is possible to prevent foreign substances from being attached to the base member used for the electroluminescent substrate and to thus perform high-quality color display.

Furthermore, the present invention provides a method for manufacturing an electronic apparatus having an electro-optical device and controlling means for controlling the operation of the electro-optical device, and the method comprises a step of performing a method for manufacturing an electro-optical device as described above. For example, mobile telephones, portable information terminals, PDAs, digital cameras, and other various apparatuses can be used as such electronic apparatuses.

According to the method for manufacturing the electro-optical device of the present invention, it is possible to prevent foreign substances from being included inside the electro-optical device and to perform high-quality color display. Therefore, according to the method for manufacturing the electronic apparatus of the present invention which are achieved by the method for manufacturing the electro-optical device, it is possible to manufacture an electronic apparatus having a high-quality displaying unit.

### BRIEF DESCRIPTION OF THE DRAWINGS

FIG. 1 is a perspective view illustrating an example of an apparatus for manufacturing a color filter substrate and an apparatus for manufacturing an electroluminescent substrate according to the present invention.

FIG. 2 is a circuit block diagram illustrating a controlling system of the manufacturing apparatus illustrated in FIG. 1.

FIG. 3 is a perspective view illustrating a material discharging portion of the manufacturing apparatus illustrated in FIG. 1.

FIG. 4 is a perspective view illustrating the internal structure of a main part of the material discharging portion illustrated in FIG. 3 with a part thereof cut out.

FIG. 5 is a cross-sectional view taken along the line D-D of FIG. 4.

FIGS. 6(a)-(d) illustrate the main processes of an embodiment of a method for manufacturing a color filter substrate according to the present invention.

FIGS. 7(e)-(h) illustrate the process continued from FIG. 6.

FIGS. 8(i)-(k) illustrate the process continued from FIG. 7. In particular, FIG. 8(k) illustrates an embodiment of a desired color filter substrate.

FIGS. 9(a)-(c) illustrate examples of arranging a plurality of filter components. FIG. 9(a) illustrates a stripe arrangement, FIG. 9(b) illustrates a mosaic arrangement, and FIG. 9(c) illustrates a delta arrangement.

FIG. 10 is a view illustrating a method for manufacturing an electro-optical device according to the present invention and is a cross-sectional view illustrating a cross section of a liquid crystal device that is an embodiment of an electro-optical device.

FIGS. 11(a)-(d) illustrate the main processes of an embodiment of a method for manufacturing an electroluminescent substrate according to the present invention.

FIGS. 12(e)-(h) illustrate the process is a flowchart continued from FIG. 11.

FIGS. 13(i)-(l) illustrate the process is a flowchart continued from FIG. 12.

FIGS. 14(m)-(o) illustrate the process is a flowchart continued from FIG. 13.

FIGS. 15(p)-(r) illustrate the process is a flowchart continued from FIG. 14.

FIG. 16 is a cross-sectional view illustrating a cross section of one pixel of the electroluminescent device.

FIG. 17 is a circuit diagram illustrating an equivalent circuit of the electroluminescent device shown in FIG. 16.

FIG. 18 is a block diagram illustrating an example of an electronic apparatus manufactured by the method for manufacturing the electronic apparatus according to the present invention.

FIG. 19 illustrates a digital camera that is an example of the electronic apparatus manufactured by the method for manufacturing the electronic apparatus according to the present invention.

### DETAILED DESCRIPTION

Embodiment of Apparatus for Manufacturing Color Filter Substrate and Method for Manufacturing the Same

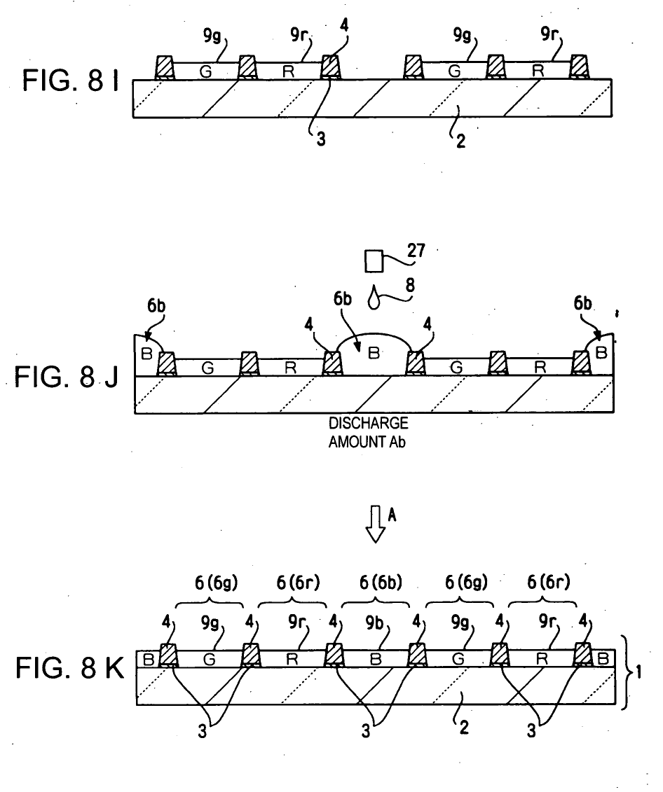

An embodiment of an apparatus for manufacturing a color filter substrate and a method for manufacturing the same according to the present invention will now be described; however, the present invention is not limited to this embodiment. The method for manufacturing the color filter substrate, which will now be described, is used for manufacturing a color filter substrate 1, as illustrated in FIG. 8(k).

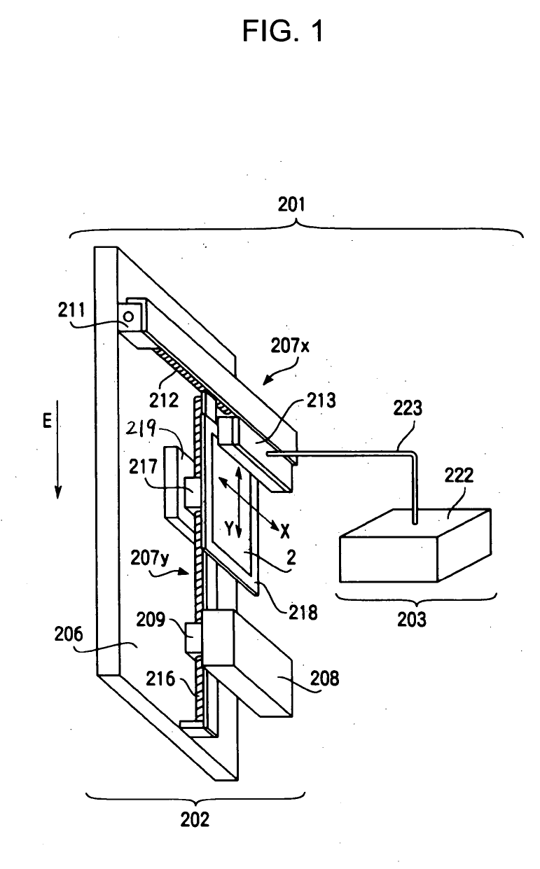

Prior to describing the method for manufacturing the color filter substrate, an apparatus for manufacturing the color filter substrate, by which the method for manufacturing the color filter substrate is realized, will now be described. FIG. 1 illustrates an example of such an apparatus for manufacturing the color filter substrate. A manufacturing apparatus 201 includes a filter forming unit 202 and a filter material supplying unit 203. The filter forming unit 202 includes a base 206, an X-direction driving system 207x provided on the base 206, and a Y-direction driving system 207y provided on the base 206.

The manufacturing apparatus 201 is provided in the clean room. The clean room is commonly used for manufacturing precise electronic parts such as semiconductor devices. Air flows from the top to the bottom as illustrated by arrow E and foreign substances, such as dust and the like, are withdrawn by the airflow. As a result, the inside of the clean room is maintained clean.

The X-direction driving system 207x includes a driving motor 211 and a screw axis 212 driven by the driving motor 211 and rotating around the axis thereof. A recording head 213 is screw-engaged with the screw axis 212. When the screw axis 212 rotates in a clockwise or counterclockwise direction due to the operation of the driving motor 211, the recording head 213 screw-engaged with the screw axis 212 reciprocally moves in the direction of arrow X.

The Y-direction driving system 207y includes a screw axis 216 fixed to the base 206, a driving motor 217 for rotating an engaging member engaged with the screw axis 216, and a stage 218 fixed to the driving motor 217. The stage 218 functions as a base member supporting means for supporting a base member 2 of a color filter substrate that undergoes a filter forming process. The base member 2 is fixed to the stage 218 by air absorption (vacuum) or by an appropriate mechanical clamp mechanism so as not to have a positional error. When the engaging member rotates in the clockwise or counterclockwise direction due to the operation of the Y-direction motor 217, the stage 218 is guided by the screw axis 216 and reciprocally moves in the-direction of arrow Y. The Y-direction is perpendicular to the X-direction.

The stage 218 is vertically or perpendicularly arranged, that is, is arranged at a right angle to horizontal, or is nearly perpendicularly or substantially vertically arranged. That the stage 218 is almost perpendicularly arranged means that the stage 218 is arranged at an angle that is not appreciably different from the right angle. As mentioned above, since the stage 218 is vertically or perpendicularly arranged (or substantially vertically/perpendicularly arranged), the base member 2 supported by the stage 218 is substantially vertically arranged.

A cleaning device 208 is provided on the screw axis 216 constituting the Y-direction driving system 207y. The output axis of a motor 209 integrated with the cleaning device 208 is screw-engaged with the screw axis 216. When the cleaning device 208 is transferred to the recording head 213 by the operation of the motor 209, the recording head 213 may be cleaned by the cleaning device 208.

An ionizer 219 as an ion supplying means is fixed to the surface of a base 206 facing the rear surface of the stage 218. Since the structure of the ionizer 219 is well known, the detailed description thereof will be omitted. The ionizer 219 generates ions having the electric potential opposite to the charged electric potential of the base member 2 supported by the stage 218 and supplies the ions to the stage 218. In order to reliably supply the ions to the stage 218, the ionizer 219 preferably has a blast device for causing the generated ions to flow to the stage 218, for example, a blast device including a rotating fan.

It is possible to prevent the base member 2 from being charged with electricity or to discharge the electricity charged to base member 2 by supplying ions to the stage 218 using the ionizer 219. As a result, it is possible to prevent foreign substances from being attached to the base member 2 due to static electricity. Also, since the ionizer 219 according to the present embodiment is formed so as to supply ions from a side of the base member 2 that does not face the recording head 213, it is possible to supply a sufficient amount of ions to the base member 2 and to prevent the movement of the recording head 213 from being obstructed by the presence of the ionizer 219.

A container 222 for storing a filter material is provided in a filter material supplying unit 203. The container 222 and the recording head 213 are connected to each other by a pipe 223. A liquid material in the container 222, that is, the filter material is supplied to the recording head 213 through the pipe 223.

According to the present embodiment, when color filters are formed to have three colors R, G, and B, three kinds of manufacturing apparatuses 201 for the colors R, G, and B are provided in different positions. A filter material corresponding to each of the colors R, G, and B is stored in the container 222 of each manufacturing apparatus 201.

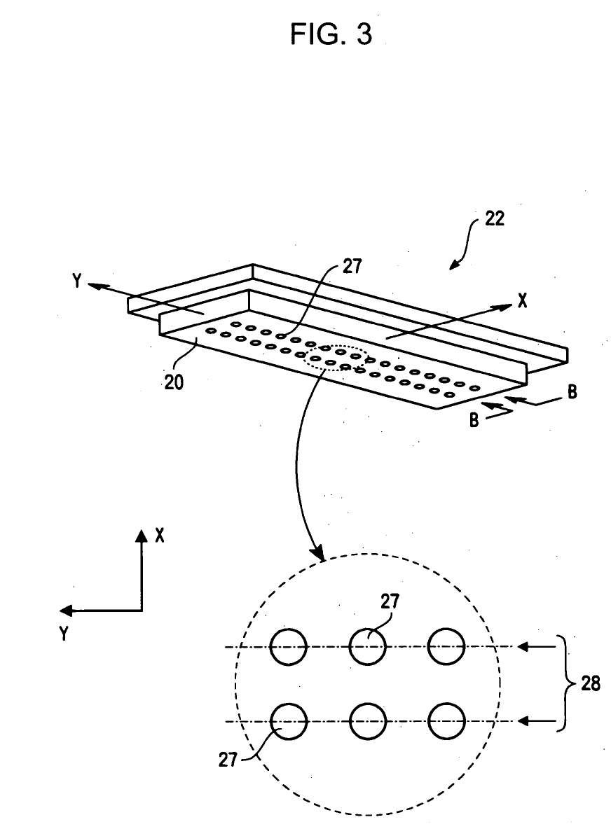

For example, one or a plurality of inkjet heads 22, illustrated in FIG. 3, is provided on the bottom surface of the recording head 213 constituting the filter forming unit 202 of FIG. 1. The inkjet head 22 includes a substantially rectangular casing 20 whose bottom surface is provided with a plurality of nozzles 27. Each of the nozzles 27 has a minute aperture with a diameter of about 0.02 mm to 0.1 mm.

According to the present embodiment, the plurality of nozzles 27 are provided in two rows to thus form two nozzle rows 28. In each nozzle row 28, the nozzles 27 are provided in a straight line so as to be separated from each other by a predetermined distance. A liquid material, that is, the filter material is supplied to the nozzle rows 28 in the direction of arrow B. The supplied filter material is discharged from the nozzles 27 as minute liquid drops in accordance with the vibration of piezoelectric elements. The number of nozzle rows 28 may be one, or three or more.

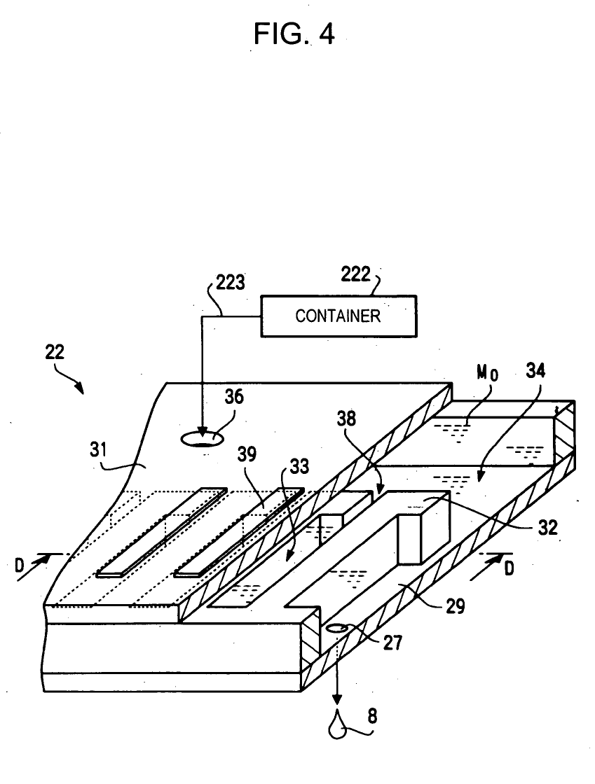

As illustrated in FIG. 4, the inkjet head 22 includes a nozzle plate 29 made of stainless steel, a vibration plate 31 arranged to face the nozzle plate 29, and a plurality of partitioning members 32 for connecting the nozzle plate 29 to the vibration plate 31. In addition, a plurality of storage chambers 33 for storing the filter material and a liquid storing portion 34 for temporarily storing the filter material are formed by the partitioning members 32 between the nozzle plate 29 and the vibration plate 31. Furthermore, the plurality of storage chambers 33 communicate with the liquid storing portion 34 through paths 38. A hole 36 for supplying the filter material is formed at an appropriate position of the vibration plate 31. The container 222 is connected to the supplying hole 36 through the pipe 223 illustrated in FIG. 1. The filter material MO supplied from the container 222 is first filled in the liquid storage portion 34 and is then filled in the storage chambers 33 through the paths 38.

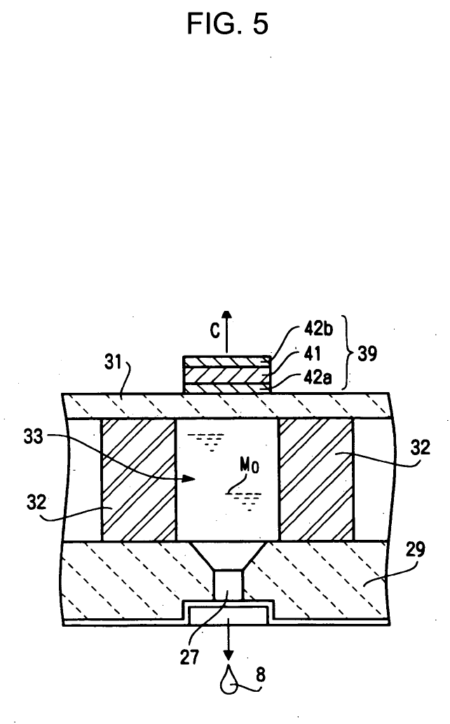

The nozzles 27 for spraying the filter material from the storage chambers 33 are provided in the nozzle plate 29 constituting a part of the inkjet head 22. It was previously described with reference to FIG. 3 that the nozzle rows 28 are formed by arranging the plurality of nozzles 27. Pressing members 39 for pressing the filter material are mounted on the surface of the vibration plate 31 that faces the storage chambers 33. As illustrated in FIG. 5, each of the pressing members 39 includes a piezoelectric element 41 and a pair of electrodes 42a and 42b between which the piezoelectric element 41 is sandwiched.

The piezoelectric element 41 is outwardly bent in the direction of arrow. C when current is applied to the electrodes 42a and 42b, thereby increasing the volume of the storage chamber 33. When the volume of the storage chamber 33 increases, the filter material MO corresponding to the increased volume flows from the liquid storage portion 34 into the storage chamber 33 through the path 38.

When current is not applied to the piezoelectric element 41, the piezoelectric element 41 and the vibration plate 31 recover their original shapes, and the storage chambers 33 recover their original volumes. Therefore, the pressure to the filter material in the storage chambers 33 increases, and thus the filter material is discharged from the nozzles 27 as liquid drops 8. The liquid drops 8 are stably discharged from the nozzles 27 as minute liquid drops regardless of the kind of solvent included in the filter material.

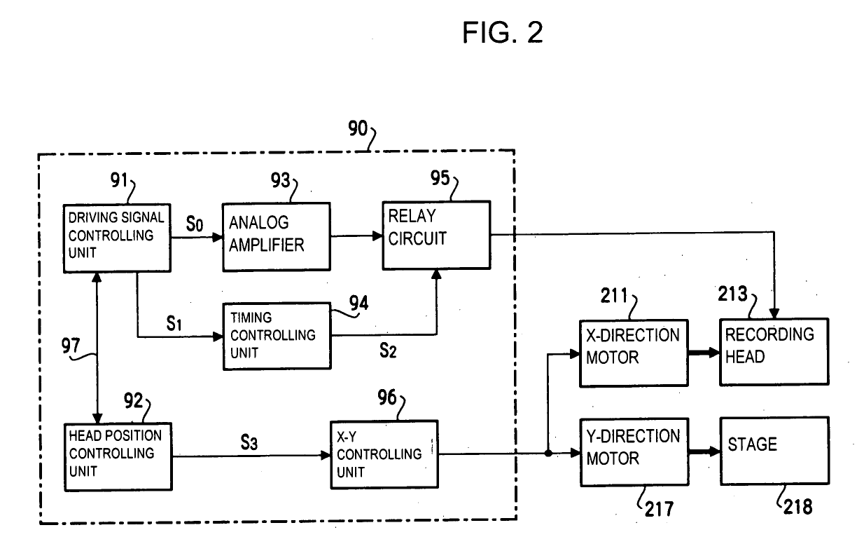

The apparatus 201 for manufacturing the color filter substrate includes a controlling device 90 illustrated in FIG. 2. The controlling device 90 controls the operation of the X-direction motor 211, the Y-direction motor 217, and the recording head 213 included in the filter forming unit 202 of FIG. 1. In addition, the manufacturing apparatus 201 also has a controlling unit for controlling the operation of the cleaning motor 209 shown in FIG. 1. However, a detailed description of the controlling unit will be omitted.

The controlling device 90 includes a driving signal controlling unit 91 composed of a computer and a head position controlling unit 92 composed of a computer. The driving signal controlling unit 91 and the head position controlling unit 92 can share information through a signal line 97. The driving signal controlling unit 91 outputs a waveform S0 for driving the recording head 213 to an analog amplifier 93. In addition, the driving signal controlling unit 91 outputs to a timing controlling unit 94 bit map data S1 describing to which positions the filter material is discharged.

The analog amplifier 93 amplifies the waveform S0 and transfers the amplified waveform S0 to a relay circuit 95. The timing controlling unit 94, in which a clock pulse circuit is provided, outputs a discharge timing signal S2 to the relay circuit 95 in accordance with the bit map data S1. The relay circuit 95 outputs the waveform S0 transferred from the analog amplifier 93 to the input port of the recording head 213 in accordance with the discharge timing signal S2 transferred from the timing controlling unit 94.

The head position controlling unit 92 outputs information S3 on the position of the recording head 213 to an X-Y controlling circuit 96. The X-Y controlling circuit 96 outputs a signal for controlling the position of the recording head 213 in the X-direction to the X-direction motor 211 and outputs a signal for controlling the position of the stage 218 in the Y-direction to the Y-direction motor 217 based on the transferred information S3 on the position of the recording head 213.

In accordance with the above-mentioned structures of the driving signal controlling unit 91 and the head position controlling unit 92, when the recording head 213 is located at the desired coordinates on the base member 2 mounted on the stage 218, the recording head 213 discharges the filter material as liquid drops thereto. As a result, the liquid drops of the filter material are applied to the desired positions on the base member 2.

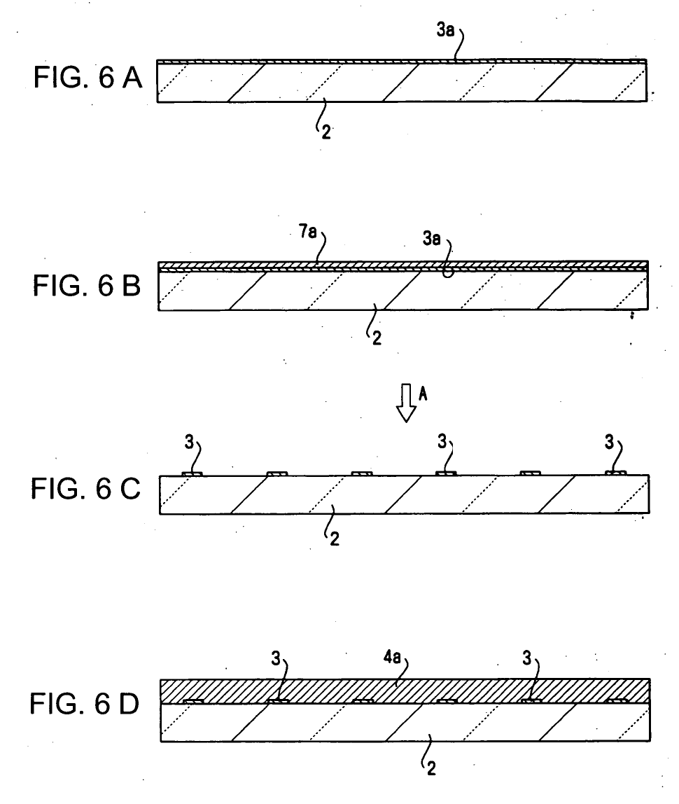

A method for manufacturing a color filter substrate, in which the inkjet head 22 illustrated in FIG. 3 is used, will now be described. In FIGS. 6 to 8, processes of performing such a manufacturing method are sequentially illustrated. FIG. 8(k) illustrates a desired color filter substrate 1.

In FIG. 6(a), a metal thin film 3a is formed on the base member 2, which is made of transmissive glass, transmissive plastic, or the like by a dry plating method using materials for forming a light shielding layer 3 such as Cr, Ni, and Al. In this case, the thickness of the metal thin film 3a is preferably about 0.1 to 0.5 μm.

Next, as shown in FIG. 6(b), a resist 7a that is a photosensitive resin is applied with a uniform thickness. The resist 7a is exposed with a mask covering it and is then developed to thus form the resist 7a of a predetermined pattern. Subsequently, the light shielding layer 3 in a predetermined shape, that is, in a lattice shape as seen from arrow A, is formed as illustrated in FIG. 6(c) by etching the metal thin film 3a using the resist pattern as a mask.

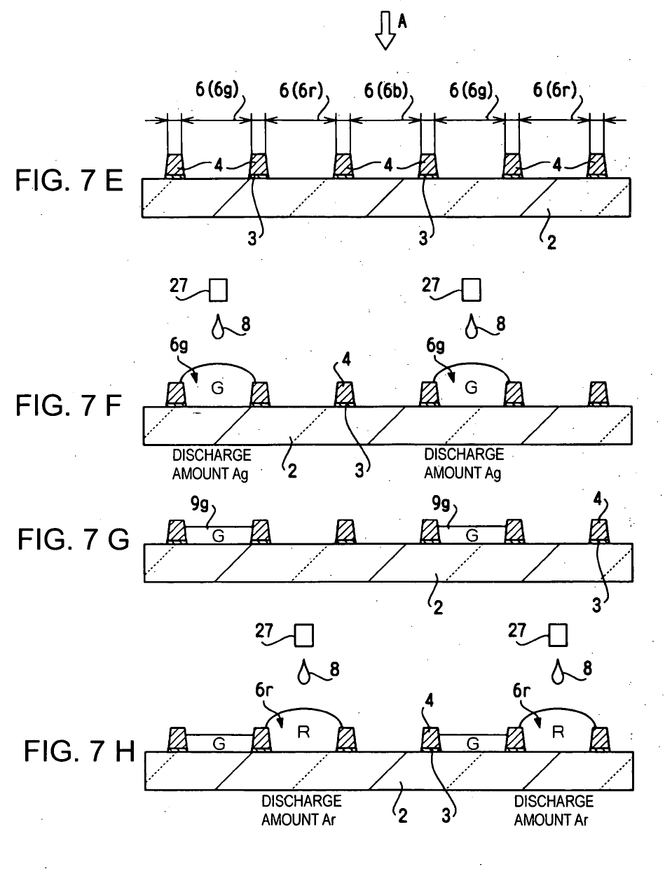

In FIG. 6(d), a photosensitive resin 4a is formed on the light shielding layer 3 with a uniform thickness, and a photolithography process is performed thereon. As a result, as illustrated in FIG. 7(e), banks 4 of a predetermined pattern are formed in the same shape as that of the light shielding layer 3, that is, in a lattice shape. At this time, the height of the banks 4 is preferably about 1.0 μm. The banks 4 function to divide the base member 2 into regions in which liquid drops are discharged.

A plurality of display dot regions 6 divided by the banks 4 are formed on the base member 2 by forming the banks 4 as mentioned above. The plurality of display dot regions 6 are arranged in a matrix as seen from the direction of arrow A since the banks 4 are formed in a lattice shape. Furthermore, it is not necessary to make the banks 4 black, and urethane-based or acryl-based hardened photosensitive resin compositions may be used for the banks 4.

The main role of the banks 4 is to store the filter material in the display dot regions 6. The filter material is preferably not attached to-the surfaces of the banks 4. Therefore, the material of the banks 4 preferably has the property of repelling the filter material, that is, a liquid repellent property. Therefore, the banks 4 are preferably made of fluorine-based resin, silicon resin, titania-containing resin, and the like.

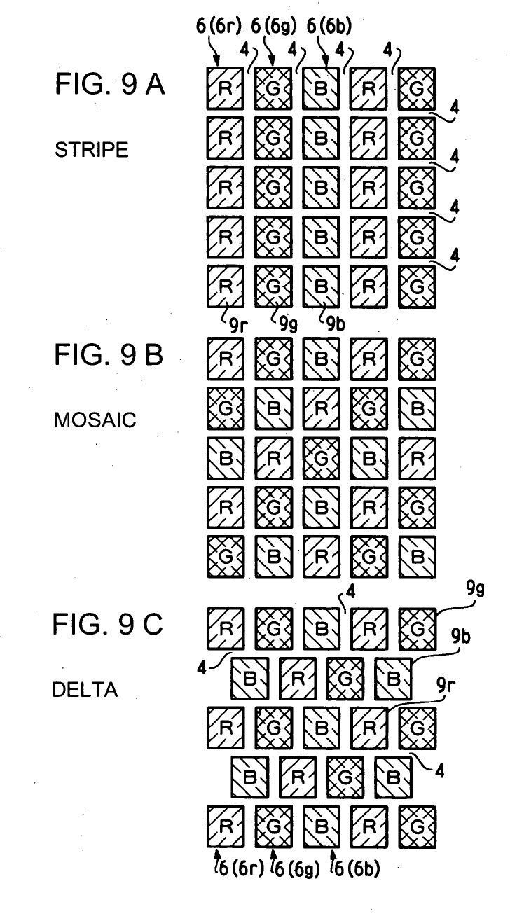

As mentioned above, after forming the banks 4 on the base member 2, the base member 2 is mounted at a predetermined position on the stage 218 in FIG. 1. Next, the X-direction driving system 207x and the Y-direction driving system 207y are operated, and the pressing members 39 shown in FIG. 4 are operated to thus perform the following color filter forming processes. According to the present embodiment, as illustrated in FIG. 9(a), G color filter components 9g, R color filter components 9r, and B color filter components 9b are arranged in a stripe arrangement. In the stripe arrangement, each of the colors R, G, and B is arranged in the column direction, and the colors R, G, and B are repeatedly arranged in this order in the row direction.

In FIG. 9, in addition to the stripe arrangement, a mosaic arrangement is illustrated in FIG. 9(b), and a delta arrangement is illustrated in FIG. 9(c). In the mosaic arrangement, the colors R, G, and B are repeatedly arranged in this order in the column and row directions. In the delta arrangement, the colors R, G, and B are arranged at positions corresponding to the apexes of a triangle and are sequentially and repeatedly arranged in the row direction. The mosaic arrangement or the delta arrangement can be employed instead of the stripe arrangement.

In the color filter forming process, as shown in FIG. 7(f), the filter material of the color G is discharged as the liquid drops 8 into display dot regions 6g, in which the filter components of the color G are to be formed, by the inkjet head 22 illustrated in FIG. 3. The liquid drops 8 are discharged into one display dot region several times. The total amount Ag of the discharged liquid drops is previously set to be larger than the volume of the display dot regions 6g, which is defined by the height of the banks 4. Therefore, the discharged filter material of the color G protrudes above the banks 4. Then, the solvent included in the filter material of the color G is evaporated by heating the filter material of the color G at a temperature of 50° C. for ten minutes to thus pre-bake the filter material of the color G. As a result, the surface of the filter material of the color G is planarized as illustrated in FIG. 7(g), thereby forming the filter components 9g of the color G.

Next, in FIG. 7(h), the filter material of the color R is discharged as the liquid drops 8 into display dot regions 6r, in which the filter components of the color R are to be formed, by the inkjet head 22 illustrated in FIG. 3. The total amount Ar of the discharged liquid drops is also set to be larger than the volume of the display dot regions 6r, which is defined by the height of the banks 4. The discharged filter material of the color R protrudes above the banks 4. Then, the solvent included in the filter material of the color R is evaporated by heating the filter material of the color R at a temperature of 50° C. for ten minutes to pre-bake the filter material of the color R. As a result, the surface of the filter material of the color R is planarized as illustrated in FIG. 8(i), thereby forming the filter components 9r of the color R.

Next, in FIG. 8(j), the filter material of the color B is discharged as the liquid drops 8-into display dot regions 6b, in which the filter components of the color B are to be formed, by the inkjet head 22 illustrated in FIG. 3. The total amount Ab of the discharged liquid drops is also set to be larger than the volume of the display dot regions 6b, which is defined by the height of the banks 4. The discharged filter material of the color R protrudes above the banks 4. Then, the solvent included in the filter material of the color B is evaporated by heating the filter material of the color B at a temperature of 50° C. for ten minutes to pre-bake the filter material of the color B. As a result, the surface of the filter material of the color B is planarized as illustrated in FIG. 8(k), thereby forming the filter components 9b of the color B.

Subsequently, the filter components are hardened by heating them, for example, at a temperature of 230° C. for thirty minutes to thus post-bake the filter components. As a result, the color filter, in which the filter components 9g, 9r, and 9b of the colors R, G, and B are arranged in a predetermined arrangement, for example, in the delta arrangement illustrated in FIG. 9(a), is formed. At the same time, the color filter substrate 1 composed of the base member 2 and the color filter is formed.

According to the present embodiment, as illustrated in FIG. 1, since the stage 218 is vertically provided, the base member 2 supported by the stage 218 is vertically maintained. The filter material is discharged from the recording head 213 to the base member 2 as liquid drops. Since the manufacturing apparatus 201 is placed in the current of air that flows from the top to the bottom in the direction of arrow E, foreign substances, such as dusts, are easily mounted on the base member 2 when the base member 2 is horizontally provided. Therefore, it is difficult to manufacture a high-quality color filter substrate at a high yield. However, according to the present embodiment, since the base member 2 is vertically maintained, hardly foreign substances are mounted on the surface of the base member 2. Therefore, it is possible to manufacture a high-quality color filter substrate at a high yield.

Modification

According to the above embodiment, the stage 218 is vertically arranged in FIG. 1. Therefore, the base member 2 is also vertically arranged. However, the stage 218 may be inclined at an angle of 0° to ±5° with respect to the perpendicular line. According to an experiment of the present inventors, it is possible to effectively prevent foreign substances from being attached to the base member 2 when the stage 218 is vertically arranged. However, when the angle at which the stage 218 is inclined with respect to the perpendicular line is limited to within ±5°, it is possible to prevent the foreign substances from being attached to the base member 2 such that the base member 2 can be practically used.

According to the above embodiment, the three colors R, G, and B are considered as the filter components that constitute color filters. However, the colors C (cyan), M (magenta), and Y (yellow) may be used for the filter components in addition to the colors R, G, and B. Furthermore, according to the above embodiment, the filter components 9g, 9r, and 9b are arranged in the stripe arrangement illustrated in FIG. 9(a). However, the mosaic arrangement illustrated in FIG. 9(b) or the delta arrangement illustrated in FIG. 9(c) may be employed instead of the stripe arrangement.

### EMBODIMENT OF METHOD FOR MANUFACTURING ELECTROLUMINESCENT SUBSTRATE

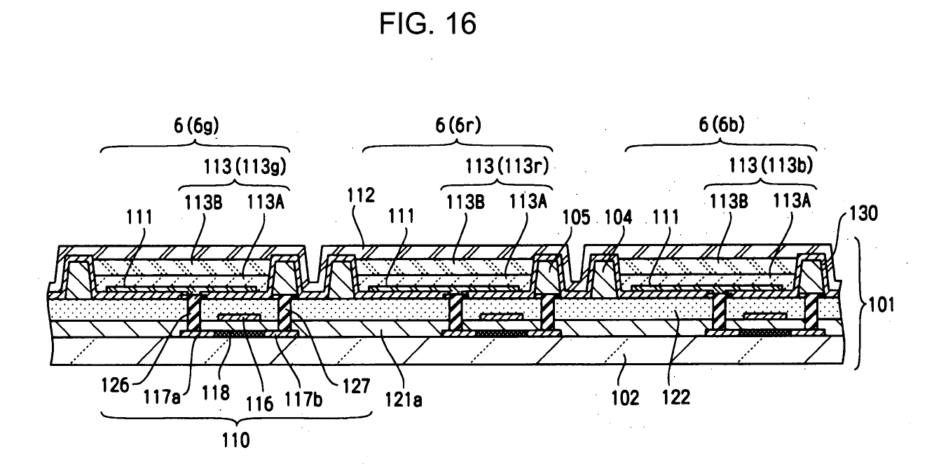

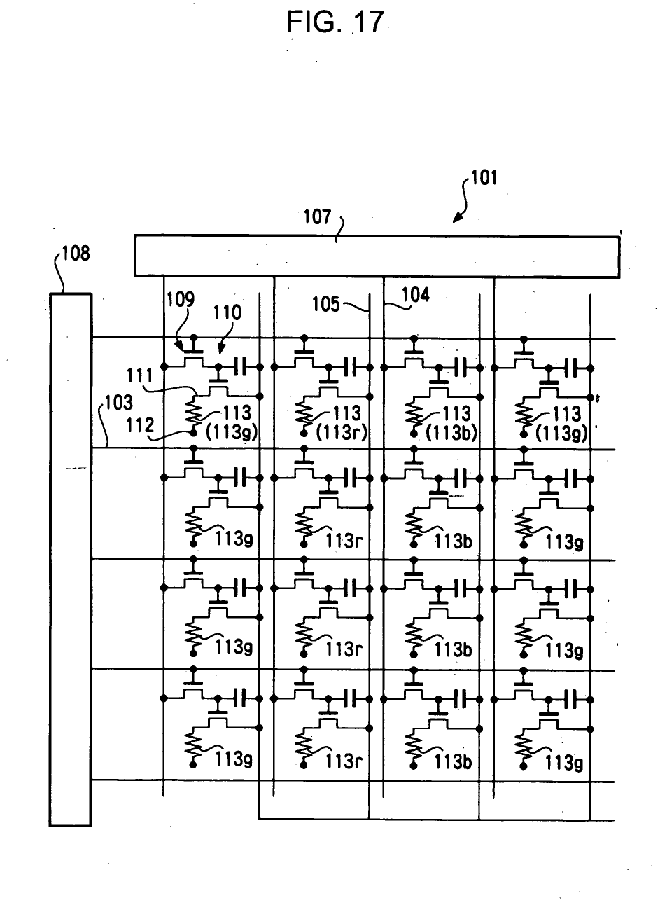

A method for manufacturing an electroluminescent substrate according to the present invention will now be described with reference to a case where the electroluminescent substrate used for the electroluminescent device illustrated in FIGS. 16 and 17 is manufactured. Also, the present invention is not limited to the embodiment.

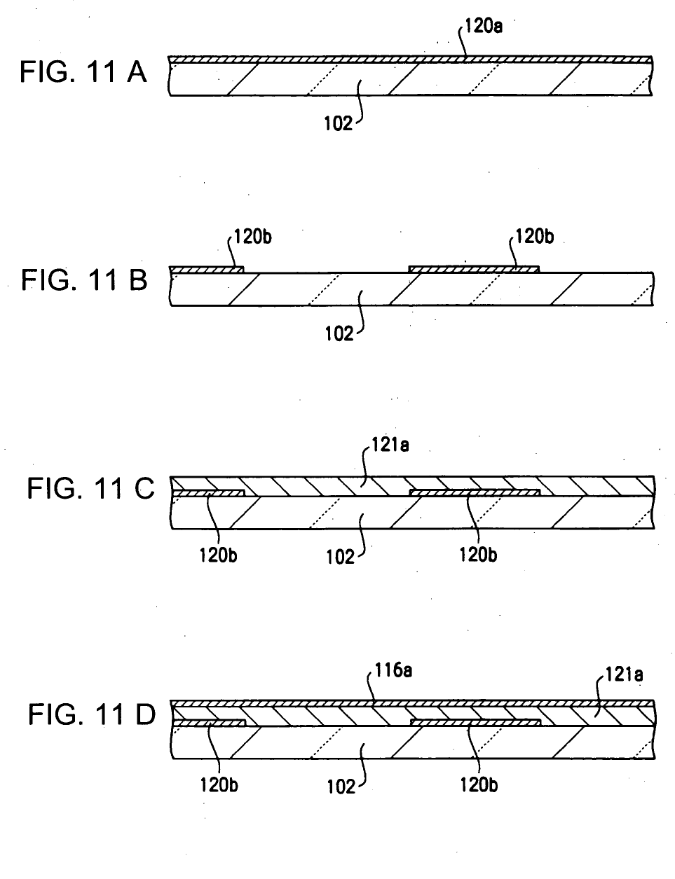

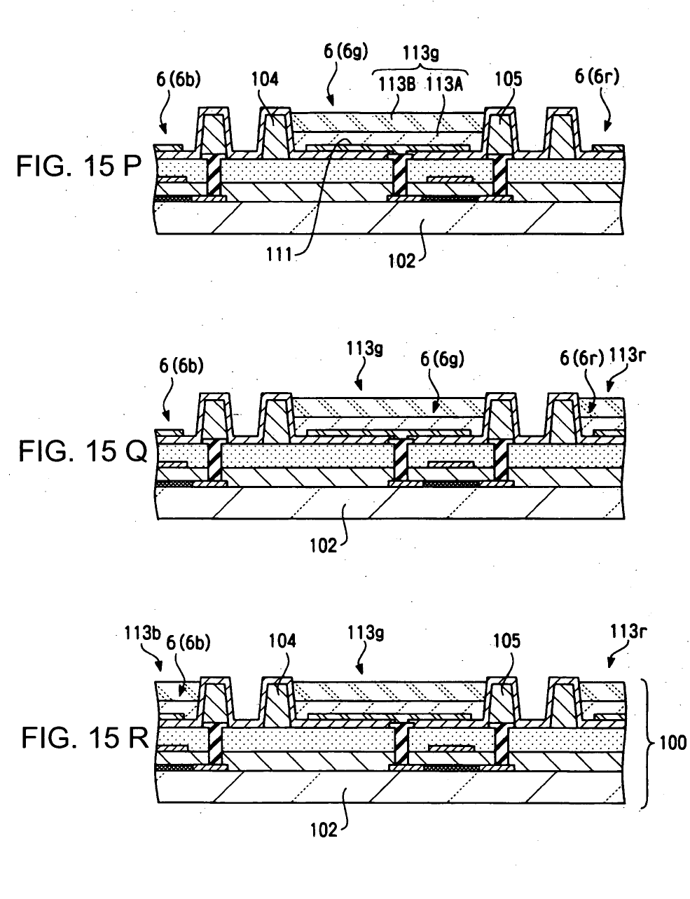

FIGS. 11 to 15 illustrate an embodiment of the method for manufacturing the electroluminescent substrate in the order of processes. The manufacturing method is used for manufacturing the electroluminescent substrate 100 illustrated in FIG. 15(r). When the electroluminescent substrate 100 is manufactured, in FIG. 11(a), a base protecting layer (not shown) composed of a silicon oxide film is formed on a transmissive base member 102 by a plasma chemical vapor deposition (CVD) method using tetraethoxysilane (TEOS) or oxygen gas as a source gas, preferably, to a thickness of about 2,000 to 5,000 Å.

Next, the temperature of the base member 102 is set to about 350° C. and a semiconductor film 120a that is an amorphous silicon film is formed on the surface of the base protecting layer by the plasma CVD method to a thickness of about 300 to 700 Å. Then, a crystallizing process, such as a laser anneal or a solid state growth method is performed on the semiconductor film 120a to crystallize the semiconductor film 120a into a polysilicon film.

Next, a resist film is formed on the semiconductor film 120a, and a resist mask is formed by exposing and developing the resist film. Then, the semiconductor film 120a is patterned using the resist mask. As a result, isolated semiconductor films 120b illustrated in FIG. 11(b) are formed.

Next, as illustrated in FIG. 11(c), a gate insulating film 121a composed of a silicon oxide film or a nitride film is formed on the surfaces of the base member 102 on which the semiconductor films 120b are formed by the plasma CVD method using TEOS or oxygen gas as a source gas, preferably, to a thickness of about 600 to 1,500 Å. The semiconductor films 120b become a channel region and source and drain regions of the current thin film transistor 110 (see FIG. 17). In another section, semiconductor films (not shown) that are a channel region and a source and drain region of the switching thin film transistor 109 (see FIG. 17) are also formed. According to the manufacturing processes illustrated in FIGS. 11 to 15, since two kinds of switching thin film transistors and current thin film transistors are formed at the same time and in the same order, only the process of forming the current thin film transistor 110 will now be described, and a description of the process of forming the switching thin film transistor will be omitted.

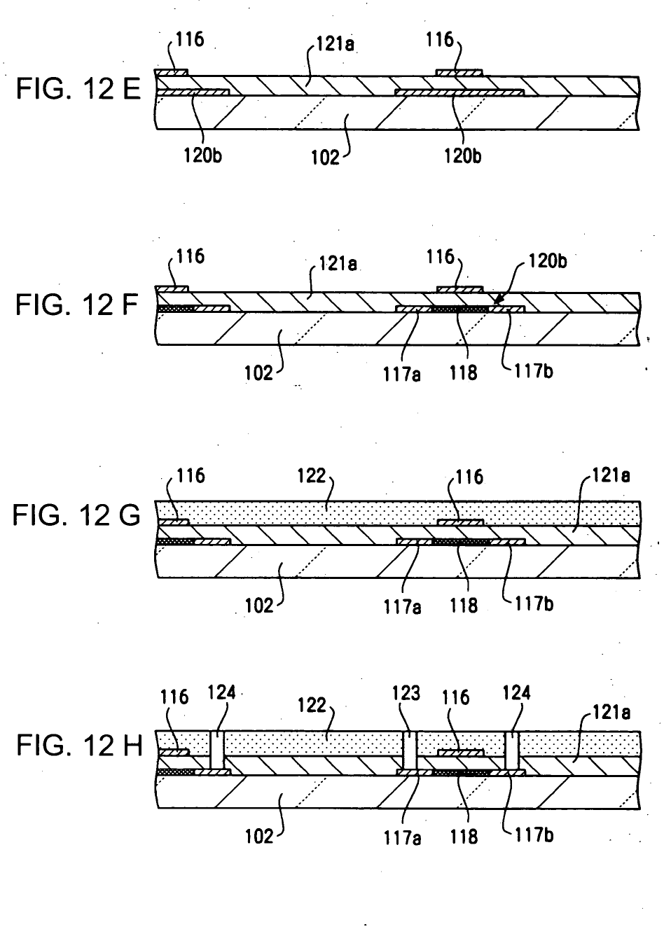

Next, in FIG. 11(d), a conductive film 116a is formed of Al or Ta by a sputtering method. Then, the conductive film 116a is coated with a resist material, and a resist mask is formed by exposing and developing the resist material. The conductive film 116a is patterned using the resist mask to form gate electrodes 116 as illustrated in FIG. 12(e).

In this state, impurities such as high temperature phosphorus ions are implanted. As a result, as illustrated in FIG. 12(f), source and drain regions 117a and 117b are self-aligned in the semiconductor films 120b with respect to the gate electrodes 116. Furthermore, the portions into which the impurities are not implanted become channel regions 118.

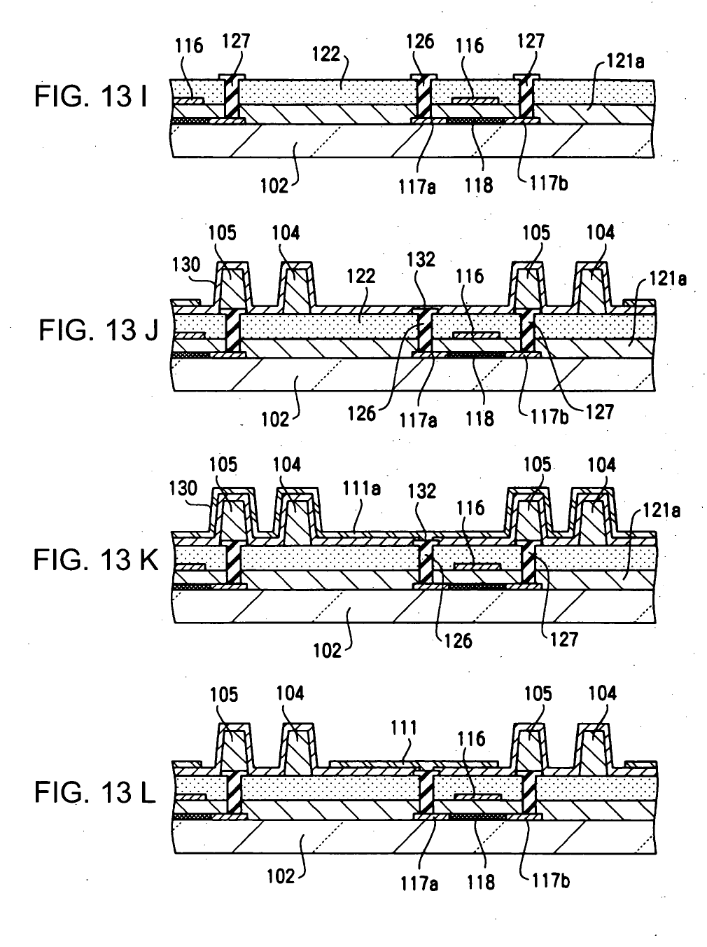

Next, in FIG. 12(g), an interlayer insulating film 122 is formed. Then, in FIG. 12(h), contact holes 123 and 124 are formed. In addition, as illustrated in FIG. 13(i), relay electrodes 126 and 127 are formed by filling a conductive material into the contact holes 123 and 124.

Furthermore, as illustrated in FIG. 13(j), signal lines 104, common power supply lines 105, and scanning lines 103 (see FIG. 17) are formed on the interlayer insulating film 122. Next, an interlayer insulating film 130 is formed so as to cover the top surfaces of the respective wiring lines, and a contact hole 132 is formed at a position corresponding to the relay electrode 126. And then, in FIG. 13(k), an indium tin oxide (ITO) film 111a is formed so as to fill the contact hole 132. Subsequently, the ITO film 111a is coated with resist, and a resist mask is formed by exposing and developing the resist. The ITO film 111a is patterned using the resist mask. As a result, as illustrated in FIG. 13(l), a pixel electrode 111 electrically connected to the source and drain regions 117a are formed in the region surrounded by the signal line 104, the common power supply line 105, and the scanning line 103.

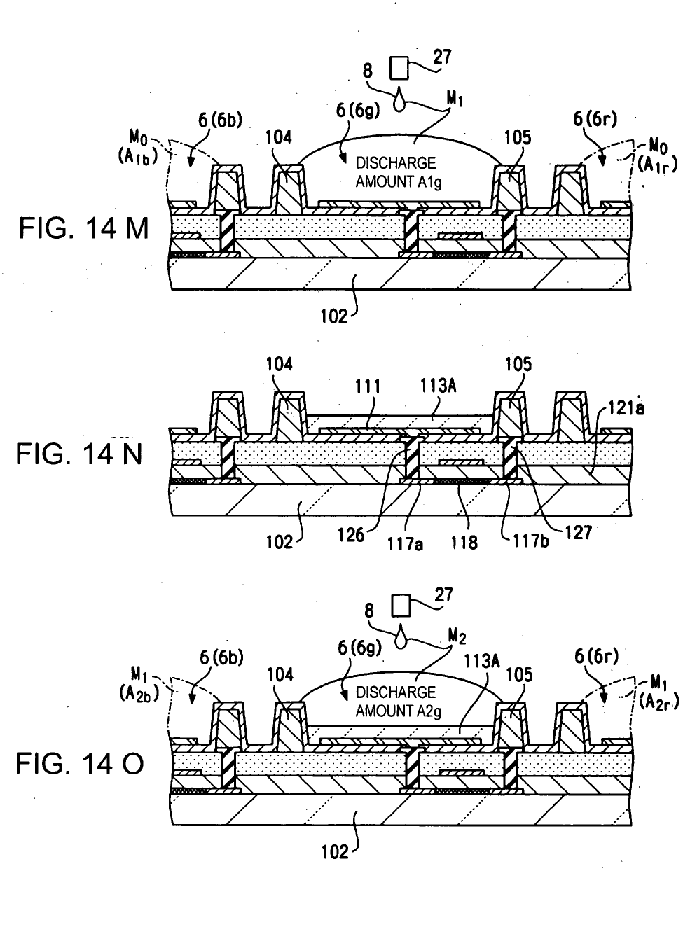

Next, as illustrated in FIGS. 14(m) to 15(r), electroluminescent elements are formed on the base member 102 using the inkjet head 22 illustrated in FIG. 3. In this case, in FIG. 14(m), the signal line 104, the common power supply line 105, and the scanning line 103 shown in FIG. 17 operate as dividing components, and the plurality of display dot regions 6 are formed on the base member 102. In addition, in FIG. 14(m), the region, in which the light-emitting element of the color G is formed, is denoted by 6g, and the region, in which the light-emitting element of the color R is formed, is denoted by 6r. Furthermore, the region, in which the light-emitting element of the color B is formed, is denoted by 6b.

First, in a state where the surface of the base member 102 faces the upper direction, a material M1 for forming a hole injecting layer 113A corresponding to the lower layer of the EL element 113g shown in FIG. 16 is discharged from the nozzle 27 of the inkjet head 22 shown in FIG. 3 as liquid drops and is selectively supplied to the first region surrounded by the dividing components 103, 104, and 105, that is, the region 6g of the color G. As a result, the region 6g is coated with the material M1.

At this time, the discharge amount A1g is previously set to be larger than the volume of the display dot region 6g, which is defined by the height of the dividing components 103, 104, and 105. The supplied light-emitting-element material of the color G protrudes above the dividing components 103, 104, and 105. Then, the solvent included in the material M1 is evaporated by heating, that is, pre-baking or the irradiation of light. As a result, as illustrated in FIG. 14(n), the hole injecting layer 113A having the flat surface is formed. When the thickness of the hole injecting layer 113A is smaller than the desired thickness,

Next, as illustrated in FIGS. 14(m) to 15(r), electroluminescent elements are formed on the base member 102 using-the inkjet head 22 illustrated in FIG. 3. In this case, in FIG. 14(m), the signal line 104, the common power supply line 105, and the scanning line 103 shown in FIG. 17 operate as dividing components, and the plurality of display dot regions 6 are formed on the base member 102. In addition, in FIG. 14(m), the region, in which the light-emitting element of the color G is formed, is denoted by 6g, and the region, in which the light-emitting element of the color R is formed, is denoted by 6r. Furthermore, the region, in which the light-emitting element of the color B is formed, is denoted by 6b.

First, in a state where the surface of the base member 102 faces the upper direction, a material M1 for forming a hole injecting layer 113A corresponding to the lower layer of the EL element 113g shown in FIG. 16 is discharged from the nozzle 27 of the inkjet head 22 shown in FIG. 3 as liquid drops and is selectively supplied to the first region surrounded by the dividing components 103, 104, and 105, that is, the region 6g of the color G. As a result, the region 6g is coated with the material M1.

At this time, the discharge amount A1g is previously set to be larger than the volume of the display dot region 6g, which is defined by the height of the dividing components 103, 104, and 105. The supplied light-emitting-element material of the color G protrudes above the dividing components 103, 104, and 105. Then, the solvent included in the material M1 is evaporated by heating, that is, pre-baking or the irradiation of light. As a result, as illustrated in FIG. 14(n), the hole injecting layer 113A having the flat surface is formed. When the thickness of the hole injecting layer 113A is smaller than the desired thickness, a process of discharging and supplying the material M1 is repeated.

Next, as illustrated in FIG. 14(o), in a state where the surface of the base member 102 faces in the upper direction, an organic semiconductor film material M2 for forming an organic semiconductor film 113B on the upper layer of the EL element 113g shown in FIG. 16 is discharged from the nozzle 27 of the inkjet head 22 shown in FIG. 3 as liquid drops and is selectively applied in the first region surrounded by the dividing components 103, 104, and 105, that is, in the region 6g of the color G. The organic semiconductor film material M2 is preferably an organic fluorescent material dissolved in a solvent.

At this time, the discharge amount A2g is previously set to be larger than the volume of the display dot region 6g, which is defined by the height of the dividing components 103, 104, and 105. The supplied organic semiconductor film material M2 protrudes above the dividing components 103, 104, and 105. Next, the solvent included in the material M2 is evaporated by heating, that is, pre-baking or the irradiation of light. As a result, as illustrated in FIG. 15(p), the organic semiconductor film 113B having a flat surface is formed on the hole injecting layer 113A. When the thickness of the organic semiconductor film 113B is smaller than the desired thickness, a process of discharging the material M2 is repeated. In this manner, the EL element 113g for emitting the light of color G is formed by the hole injecting layer 113A and the organic semiconductor film 113B.

Next, in FIG. 15(p), the processes illustrated in FIGS. 14(m) to 15(p) are repeatedly performed on the region 6r of the color R that is the second display dot region to thus form the EL element 113r that emits the light of the color R in the region 6r of the color R as illustrated in FIG. 15(q). In FIG. 15(q), after the EL element 113r of the color R is formed, the processes illustrated in FIGS. 14(m) to 15(p) are repeatedly performed on the region 6b of the color B that is the third display dot region to thus form the EL element 113b that emits the light of the color B in the region 6b of the color B as illustrated in FIG. 15(r).

As mentioned above, the EL elements 113g, 113r, and 113b of the colors G, R, and B are formed in FIG. 15(r) to thus manufacture an electroluminescent substrate 100. Thereafter, as illustrated in FIG. 16, a reflecting electrode 112 is formed on the entire surface of the base member 102 or on the stripe region, on which the EL elements 113g, 113r, and 113b are formed, for example, by a photolithography process and an etching process. If necessary, other electronic components are provided. As a result, the electroluminescent device; 101 is manufactured. In the electroluminescent device 101, one of the plurality of display dot regions 6 that are arranged in a matrix is selected and a voltage is applied between the pixel electrode 111 and the reflecting electrode 112 thereof to thus let the EL elements 113g, 113r, and 113b selectively emit light. As a result, it is possible to display images, such as characters, numbers, and figures, on the base member 102.

According to the present embodiment, when the processes illustrated in FIGS. 11 to 15 are performed, the base member 102 is vertically maintained as illustrated in FIG. 1. FIG. 1 illustrates an apparatus for discharging a light-emitting-element material from the recording head 213. However, it is preferable that the base member 102 be vertically maintained during the processes of manufacturing the electroluminescent substrate. It is possible to prevent foreign substances, such as dusts, from being mounted on the base member 102 and to thus prevent the foreign substances from being attached to the surface of the completed electroluminescent substrate by performing the processes of manufacturing the electroluminescent substrate in a state where the base member 102 is vertically maintained.

Also, the apparatus for manufacturing the electroluminescent substrate according to the present invention includes the liquid drop discharging apparatus 201 illustrated in FIGS. 1 to 5. Since the liquid drop discharging apparatus 201 is described as the color filter substrate manufacturing apparatus 201, the description thereof will be omitted.

### FIRST EMBODIMENT OF METHOD FOR MANUFACTURING ELECTRO-OPTICAL DEVICE

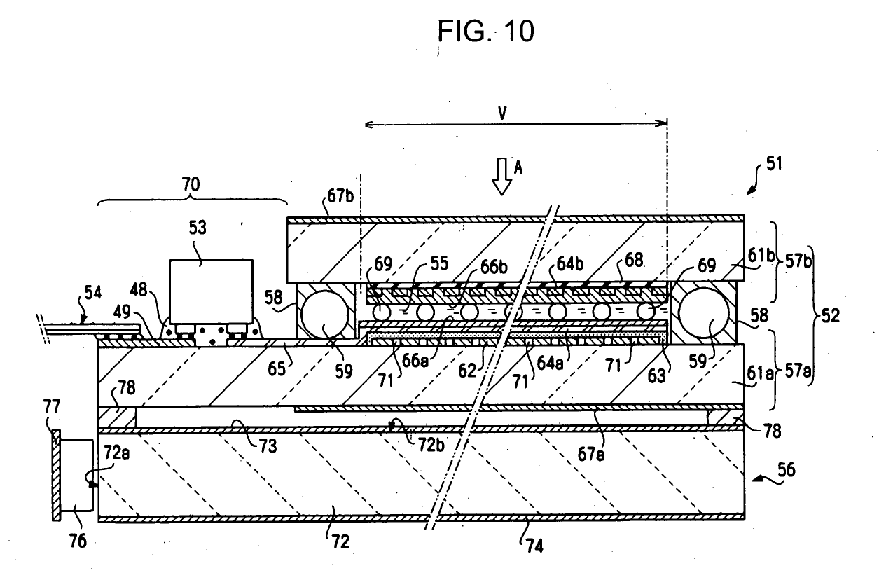

An embodiment of a method for manufacturing an electro-optical device according to the present invention will now be described with reference to a liquid crystal device that is an example of the electro-optical device. The present invention is not limited to the embodiment. FIG. 10 illustrates a transflective liquid crystal device, as an embodiment of a liquid crystal device, in which reflective display and transmissive display are selectively performed and a simple matrix method where switching elements are not used is employed.

A liquid crystal device 51 illustrated in FIG. 10 is formed by providing an illuminating device 56 and a wiring line substrate 54 to a liquid crystal panel 52. The liquid crystal panel 52 is formed by attaching a first substrate 57a that is rectangular or square as seen from the direction of arrow A to a second substrate 57b that is rectangular or square as seen from the direction of arrow A using a sealing material 58 in a ring shape as seen from the direction of arrow A.

A gap referred to as a cell gap is formed between the first substrate 57a and the second substrate 57b. Liquid crystal is injected into the cell gap to thus form a liquid crystal layer 55. Reference numeral 69 denotes spacers for maintaining the cell gap. In addition, an observer observes the liquid crystal device 51 in the direction of arrow A.

The first substrate 57a includes a first base member 61a composed of transmissive glass or transmissive plastic. A reflecting film 62 is formed on the surface of the first base member 61 a on the liquid crystal layer side. An insulating film 63 is formed on the reflecting film 62. First electrodes 64a are formed on the insulating film 63. An alignment film 66a is formed on the first electrodes 64a. A first polarizer 67a adheres to the surface of the first base member 61a on the illuminating device 56 side.

A second substrate 57b facing the first substrate 57a includes a second base member 61b composed of transmissive glass or transmissive plastic. A color filter 68 is formed on the surface of the second base member 61b on the side of the liquid crystal. Second electrodes 64b are formed on the color filter 68. An alignment film 66b is formed on the second electrodes 64b. A second polarizer 67b adheres to the outer surface of the second base member 61b.

The first electrodes 64a on the first substrate 57a are linear electrodes extending from side to side in FIG. 10. The plurality of first electrodes 64a are arranged to be parallel to each other in a direction vertical to the sheet. In short, the plurality of first electrodes 64a are formed in a stripe shape as seen from the direction of arrow A.

The second electrodes 64b on the second substrate 57b are linear electrodes extending in a direction vertical to the sheet in FIG. 10. The plurality of second electrodes 64b are arranged to be parallel to each other from side to side in FIG. 10. In short, the plurality of second electrodes 64b are formed in a stripe shape extending in a direction orthogonal to the first electrodes 64a.

The first electrodes 64a intersect the second electrodes 64b at the points arranged in a matrix as seen from the direction of arrow A. The intersections constitute dot regions for display. When color display is performed using color filters composed of filter components of the three colors R, G, and B or C, M, and Y, each of the three colors corresponds to each of the display dot regions, and one unit composed of a set of the three colors forms one pixel. An effective display region V is formed by arranging a plurality of pixels in a matrix as seen from the direction of arrow A. Images, such as characters, numbers, and figures, are displayed in the effective display region V.

Apertures 71 are formed in the reflecting film 62 so as to correspond to the display dot regions that are the minimum units of display. Planar light emitted from the illuminating device 56 passes through the apertures 71, thereby realizing transmissive display. In addition, the transmissive display may be realized by making the reflecting film 62 thin as well as by providing the apertures 71 in the reflecting film 62.

The first base member 61a includes a protruding portion 70 that protrudes from the edge of the second base member 61b. The first electrodes 64a on the first substrate 57a cross the sealing materials 58 and extend onto the protruding portion 70 to thus become a wiring line 65. Furthermore, external connection terminals 49 are formed at the edge of the protruding portion 70. A wiring line substrate 54 is electrically connected to the external connection terminals 49. The second electrodes 64b on the second substrate 57b are connected to the wiring line 65 on the first substrate 57a through conductive materials 59 dispersed in the sealing material 58. In addition, the conductive material 59 is illustrated to have almost the same width as that of the sealing material 58 in FIG. 10. However, the width of the conductive material 59 is actually smaller than that of the sealing material 58. Therefore, the plurality of conductive materials 59 commonly exist in the direction of the width of the sealing material 58.

A driving IC 53 adheres between the wiring line 65 and the external connection terminals 49 by an anisotropic conductive film (ACF) 48 on the surface of the protruding portion 70. The bumps of the driving IC 53 are electrically connected to the wiring line 65 and the external connection terminals 49 by the ACF 48. With such a mounting structure, signals and voltage are supplied from the wiring line substrate 54 to the driving IC 53. In addition, scanning signals and data signals from the driving IC 53 are transmitted to the first electrodes 64a or the second electrodes 64b.

In FIG. 10, the illuminating device 56 is provided on the rear surface of the liquid crystal panel 52 as seen from the observer with a buffer material 78 interposed therebetween and functions as a backlight. The illuminating device 56 includes a light emitting diode (LED) 76, as a light source supported by a substrate 77, and a light guiding body 72. A diffuser sheet 73 is provided on the surface of the light guiding body 72 on the side of the observer. A reflector sheet 74 is provided on a surface opposite thereto. The light emitted from the LED 76, as a point light source, is incident into the light guiding body 72 through a light receiving surface 72a of the light guiding body 72 and becomes planar light while traveling through the light guiding body 72, and then the planar light is emitted from a light emitting surface 72b.

When reflective display is performed in the liquid crystal device 51 having the above structure, external light, such as sun light and indoor light, is incident into the liquid crystal layer 55 through the second substrate 57b, is reflected from the reflecting film 62, and is supplied to the liquid crystal layer 55 again. Meanwhile, when transmissive display is performed, the LED 76 of the illuminating device 56 emits light, planar light is emitted from the light emitting surface 72b of the light guiding body 72, and the light is supplied to the liquid crystal layer 55 through the plurality of apertures 71 provided in the reflecting film 62.

In a case where light is supplied to the liquid crystal Payer 55, when scanning signals are supplied to either the first electrodes 64a or the second electrodes 64b and data signals are supplied to the other one, a predetermined voltage is applied to display dots to which the corresponding data signals are supplied. Therefore, liquid crystal is driven, and the light supplied to the corresponding display dots is modulated. Such modulation is performed in each display dot in the effective display region V, that is, in each pixel. Desired images, such as characters, numbers, and figures, are formed in the effective display region V and are observed by an observer from the direction of arrow A.

The liquid crystal device 51 according to the present embodiment is characterized in that a color filter 68 included therein is manufactured by the method for manufacturing the color filter substrate illustrated in FIGS. 6 to 9 using the apparatus for manufacturing the color filter substrate illustrated in FIGS. 1 to 5. Since the processes for manufacturing the color filter substrate using the manufacturing apparatus 201 illustrated in FIG. 1 is performed on the base member 2 that is vertically maintained, it is possible to prevent a foreign substance, such as dust, from being attached to the base member 2. Therefore, according to the method for manufacturing the liquid crystal device 51 using the processes for manufacturing the color filter substrate, it is possible to remarkably reduce the generation of defects on the color filter substrate.

Modification

According to the embodiment of FIG. 10, the present invention is applied to a transflective liquid crystal device in a simple matrix. However, the present invention can be applied to various liquid crystal devices, such as a transmissive liquid crystal device in a simple matrix, which does not have a reflective display function, a reflective liquid crystal device in a simple matrix, which does not have-a transmissive display function, an active matrix liquid crystal device using two terminal switching elements such as thin film diodes (TFDs), and an active matrix liquid crystal device using three terminal switching elements such as thin film transistors (TFTs).

### SECOND EMBODIMENT OF METHOD FOR MANUFACTURING ELECTRO-OPTICAL DEVICE

An embodiment of a method for manufacturing an electro-optical device according to the present invention will now be described with reference to an electroluminescent device that is an example of an electro-optical device. The present invention is not limited to such an embodiment. FIG. 17 illustrates an embodiment of the electric structure of an electroluminescent device. FIG. 16 illustrates a cross section of a part of the mechanical structure corresponding to the electric structure. Also, in the present specification, an electroluminescent substrate is a structure in which EL elements are formed on a substrate. The electroluminescent device is an electro-optical device in which a reflecting electrode or other optical components is provided on the electroluminescent substrate.

In FIG. 17, an electroluminescent device 101 includes a driving IC 107 for outputting data signals and a driving IC 108 for outputting scanning signals. The driving IC 107 outputs data signals to a plurality of signal lines 104. The driving IC 108 outputs scanning signals to a plurality of scanning lines 103. The scanning lines 103 and the signal lines 104 cross each other at a plurality of portions. Display dot regions constituting pixels are formed at the intersections. FIG. 16 illustrates a display dot region 6g of the color G, a display dot region 6r of the color-R, and a display dot region 6b of the color B. Each display dot region includes one of the EL elements of the three colors R, G, and B. The display dot regions corresponding to the three colors R, G, and B constitute one pixel.

In FIG. 17, one display dot region includes a switching thin film transistor 109, a current thin film transistor 110, a pixel electrode 111, a reflecting electrode 112, and an EL element 113. In the EL element 113, an EL element 113g that emits light of the color G, an EL element 113r that emits light of the color R, and an EL element 113b that emits light of the color B are arranged in a predetermined arrangement, for example, in a stripe arrangement. In FIG. 16, each EL element 113 is formed by stacking an organic semiconductor film 113B on a hole injecting layer 113A that is a lower layer. Furthermore, in FIG. 16, the current thin film transistors 110 are illustrated, however, the switching thin film transistors 109 that exist in another section are not illustrated.

In FIG. 16, when an appropriate display dot region is selected from the plurality of display dot regions 6 and a predetermined voltage is applied between the pixel electrode 111 and the reflecting electrode 112 therein, the EL element 113 in the corresponding display dot region 6 emits light and images such as characters, numbers, and figures are color displayed on the outside (that is, on the bottom side of FIG. 16) of the base member 102.

According to the method for manufacturing the electroluminescent device 101 of the present embodiment, the electroluminescent substrate 100 (see FIG. 15(r)) included in the electroluminescent device 101 is manufactured by the method for manufacturing the electroluminescent substrate illustrated in FIGS. 11 to 15 using the apparatus for manufacturing the electroluminescent substrate illustrated in FIGS. 1 to 5. In the processes of manufacturing the electroluminescent substrate, which are performed using the color filter substrate manufacturing apparatus 201 illustrated in FIG. 1, since the processes are performed in a state where the base member 2 (denoted by reference numeral 102 in FIG. 16) is vertically maintained, it is possible to prevent an foreign substance, such as dust, from being attached to the base member 2. Therefore, according to the method for manufacturing the electroluminescent device 101, which is performed using the processes of manufacturing the color filter substrate, it is possible to prevent the generation of defects on electroluminescent substrates 100.

### EMBODIMENT OF METHOD FOR MANUFACTURING ELECTRONIC APPARATUS

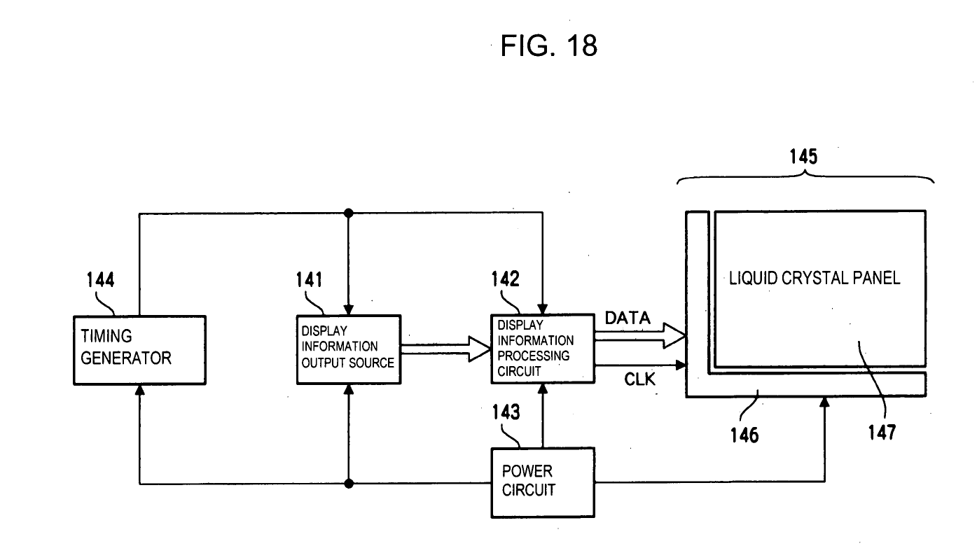

An embodiment of a method for manufacturing electronic apparatus will now be described. Prior to the description of the manufacturing method, an example of an electronic apparatus will be described with reference to FIG. 18. The electronic apparatus shown in FIG. 18 includes a display information output source 141, a display information processing circuit 142, a power circuit 143, a timing generator 144, and a liquid crystal device 145. Furthermore, the liquid crystal device 145 includes a liquid crystal panel 147 and a driving circuit 146. The liquid crystal device 51 illustrated in FIG. 10, which is manufactured by the manufacturing method illustrated in FIGS. 6 to 9 using the apparatus for manufacturing the color filter substrate illustrated in FIGS. 1 to 5, can be used as the liquid crystal device 145.

The display information output source 141 that includes a memory such as a random access memory (RAM), a storage unit such as a disk, and a resonance circuit for synchronously outputting digital image signals, supplies-display information such as image signals of a predetermined format to the display information processing circuit 142 based on various clock signals generated from the timing generator 144.

In addition, the display information processing circuit 142 that includes a plurality of well-known circuits, such as an amplifying and inverting circuit, a rotation circuit, a gamma correcting circuit, and a clamp circuit, processes input display information and supplies the image signals to the driving circuit 146 together with clock signals CLK. Herein, a test circuit together with a scanning line driving circuit (not illustrated) and a data line driving circuit (not illustrated) are generically named as the driving circuit 146. Furthermore, the power circuit 143 supplies a predetermined voltage to the respective components.

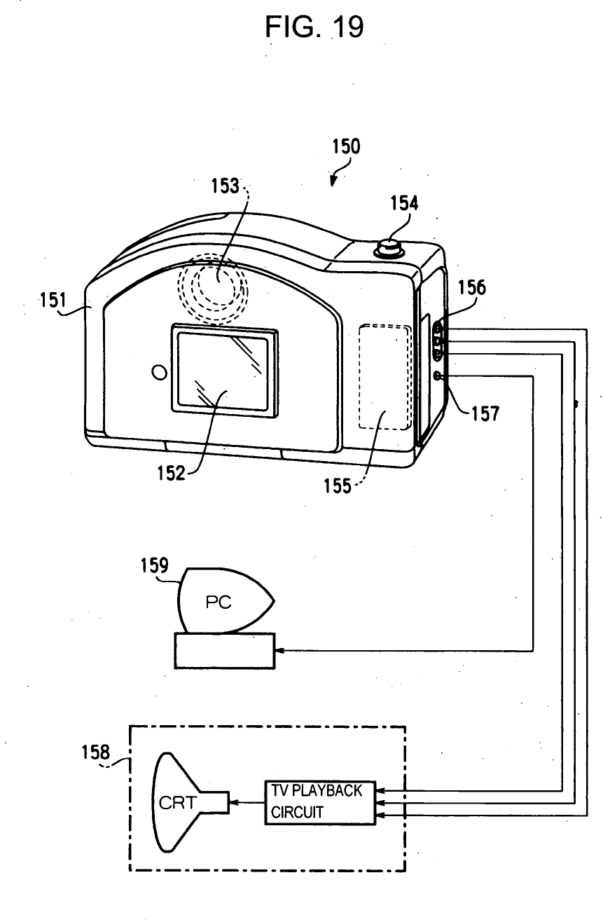

FIG. 19 illustrates a digital camera that is another example of the electronic apparatus according to the present invention, in which the liquid crystal device is used as a finder. In the digital camera 150, a liquid crystal display unit 152 is provided on the rear surface of a case 151. The liquid crystal display unit 152 functions as a finder for displaying a subject. The liquid crystal display unit 152 may be composed of the liquid crystal device 51 illustrated in FIG. 10, which is manufactured by the manufacturing method illustrated in FIGS. 6 to 9 using the apparatus for manufacturing the color filter substrate illustrated in FIGS. 1 to 5.

A light receiving unit 153 including an optical lens or a charge coupled device (CCD) is provided on the front surface (on the back surface in FIG. 19) of the case 151. When a photographer recognizes a subject displayed on the liquid crystal display unit 152 and presses a shutter 154, a photographing signal of the CCD at that point of time is transmitted to a memory of a circuit substrate 155 and is stored therein.

A video signal output terminal 156 and a data communication input and output terminals 157 are provided on the side of the case 151. A television monitor 158 may be connected to the video signal output terminal 156 if necessary, and a personal computer 159 may be connected to the data communication input and output terminals 157 if necessary. The photographing signals stored in the memory of the circuit substrate 155 are output to the television monitor 158 or the personal computer 159 by a predetermined manipulation.

### OTHER EMBODIMENTS

The present invention has been described with reference to the above-mentioned preferred embodiments. However, the present invention is not limited to the preferred embodiments, and various modifications may be made without departing from the spirit and scope of the invention as defined by the appended claims.

1. A method for manufacturing a color filter substrate having a base member and a color filter formed on the base member, the method comprising:
a step of discharging a liquid filter material from a liquid drop discharging portion to the base member as liquid drops,
wherein, in the discharging step, the liquid drops are discharged in a state where the base member is substantially vertically arranged.

2. A method for manufacturing a color filter substrate having a base member and a color filter formed on the base member, the method comprising:
a step of discharging a liquid filter material from a liquid drop discharging portion to the base member as liquid drops,
wherein, in the discharging step, the base member is inclined at an angle of about ±5° with respect to vertical.

3. A method for manufacturing a color filter substrate according to claim 1,
wherein the liquid drops are discharged from the liquid drop discharging portion substantially in a normal direction relative to the base member:

4. A method for manufacturing a color-filter substrate according to claim 1,
wherein ions having an electric potential opposite to a charged electric potential of the base member are supplied to the base member.

5. A method for manufacturing a color filter substrate according to claim 4,
wherein the ions are supplied from a side of the base member that faces away from the liquid drop discharging portion.

6. A method for manufacturing a color filter substrate according to claim 1,
wherein the base member is provided in a chamber where air current flows up and down.

7. A method for manufacturing a color filter substrate according to claim 6,
wherein a dustproof filter is provided upstream of the base member in the air current.

8. A method for manufacturing a color filter substrate according to claim 1,
wherein the liquid drop discharging portion further comprises an inkjet head using piezoelectric elements.

9. A method for manufacturing a color filter substrate according to claim 1,
wherein the liquid drop discharging portion further comprises an inkjet head that discharges a liquid filter material by bubbles generated by thermal energy.

10. An apparatus for manufacturing a color filter substrate having a base member and a color filter formed on the base member, the apparatus comprising:
base member supporting means for substantially vertically supporting the base member;
liquid drop discharging means for discharging a liquid filter material from a liquid drop discharging portion to the base member as liquid drops; and
scanning moving means for moving the base member parallel relative to the liquid drop discharging portion.

11. An apparatus for manufacturing a color filter substrate having a base member and a color filter formed on the base member, the apparatus comprising:
base member-supporting means for supporting the base member so that the base member is inclined at an angle of about ±5° with respect to vertical;
liquid drop discharging means for discharging a liquid filter material from a liquid drop discharging portion to the base member as liquid drops; and
scanning moving means for moving the base member parallel relative to the liquid drop discharging portion.

12. A method for manufacturing an electroluminescent substrate having a base member and light-emitting elements formed on the base member, the method comprising:
a step of discharging a light-emitting-element material from a liquid drop discharging portion to the base member as liquid drops,
wherein, in the discharging step, the liquid drops are discharged in a state where the base member is substantially vertically arranged.

13. A method for manufacturing an electroluminescent substrate having a base member and light-emitting elements formed on the base member, the method comprising:
a step of discharging a light-emitting-element material from a liquid, drop discharging portion to the base member as liquid drops,
wherein, in the discharging step, the base member is inclined at an angle of about ±5° with respect to vertical.

14. A method for manufacturing an electroluminescent substrate according to claim 12,
wherein the liquid drops are discharged from the liquid drop discharging portion substantially in a normal direction relative to the base member.

15. A method for manufacturing an electroluminescent substrate according to claim 12,
wherein ions having an electric potential opposite to a charged electric potential of the base member are supplied to the base member.

16. A method for manufacturing an electroluminescent substrate according to claim 14,
wherein the ions are supplied from a side of the base member facing away from the liquid drop discharging portion.

17. A method for manufacturing an electroluminescent substrate according to claim 12,
wherein the base member is provided in a chamber where air current flows up and down.

18. A method for manufacturing an electroluminescent substrate according to claim 17,
wherein a dustproof filter is provided upstream of the base member in the air current.

19. A method for manufacturing an electroluminescent substrate according to claim 12,
wherein the liquid drop discharging portion further comprises an inkjet head using piezoelectric elements.

20. A method for manufacturing an electroluminescent substrate according to claim 12,
wherein the liquid drop discharging portion further comprises an inkjet head for discharging a material by bubbles generated by thermal energy.

21. An apparatus for manufacturing an electroluminescent substrate having a base member and light-emitting elements formed on the base member, the apparatus comprising:
base member supporting means for substantially vertically supporting the base member;
liquid drop discharging means for discharging a light-emitting-element material from a liquid drop discharging portion to the base member as liquid drops; and
scanning moving means for moving the base member parallel relative to the liquid drop discharging portion.

22. An apparatus for manufacturing an electroluminescent substrate having a base member and light-emitting elements formed on the base member, the apparatus comprising:
base member supporting means for supporting the base member so that the base member is inclined at an angle of about ±5° with respect to vertical;
liquid drop discharging means for discharging a light-emitting-element material-from a liquid drop discharging portion to the base member as liquid drops; and
scanning moving means for moving the base member parallel relative to the liquid drop discharging portion.

23. A method for manufacturing an electro-optical device obtained by forming an electro-optical material layer on a color filter substrate, the method comprising:
a step of performing the method for manufacturing a color filter substrate according to claim 1.

24. A method for manufacturing an electro-optical device obtained by forming electrodes on an electroluminescent substrate, the method comprising:
a step of performing the method for manufacturing an electroluminescent substrate according to claim 11.

25. A method for manufacturing an electronic apparatus having an electro-optical device and controlling means for controlling the operation of the electro-optical device, the method comprising:
a step of performing the method for manufacturing an electro-optical device according to claim 23.
